(19) United States
(12) Patent Application Publication
(10) Pub. No.: US 2008/0197203 A1
(43) Pub. Date: Aug. 21, 2008

(54) Matrix Print Data Storage and Method for Encoding the Data

(76) Inventors: Bernhard Wirnitzer, Hemsbach (DE); Slavtcho Bonev, Mannheim (DE)

Correspondence Address: DAVID A. GUERRA;INTERNATIONAL PATENT GROUP, LLC, 2025 17TH AVENUE N.W., CALGARY, AB, T2M 0S7, omitted

(21) Appl. No.: 11/572,591

(22) PCT Filed: Jul. 26, 2005
(86) PCT No.: PCT/EP2005/008097

§ 371 Date: Dec. 20, 2007

(30) Foreign Application Priority Data
Jul. 29, 2004 (DE) 10 2004 036 809.0

(51) Int. Cl. G06K 19/06

(52) U.S. Cl. 235/494

(57) ABSTRACT

The invention relates to an item, particularly such as paper, with applied matrix printing, for the storage of encoded data with high data density, whereby the printed surface of the item is divided into matrix cells, comprising matrix points with a given form and at least two different forms R, I, are printed in each matrix cell. Each form R, I, is selected from pairs of non-overlapping forms (R₀, R₁) or (I₀, I₁), having the same area adjacent to at least one matrix point of another form in the same matrix cell and occupying various matrix points in the matrix cell.

The invention relates to an object to which a matrix print for storing digital data has been applied and a process for encoding such matrix print memory according to the generic clause of patent claims 1 and 10.

The storage of information by description of objects goes back to the Aegean and Hittite hieroglyphs. Defined patterns serve there as symbols for words, syllables or letters. For the storage of digital data the patterns are associated with a so-called information bit or a sequence of information bits.

In accordance with U.S. Pat. No. 5,315,089 non-rotationally symmetrical patterns are turned in a defined manner in order to store digital data. Further developments of this technology permit the superposition of visual information as described, e.g. in U.S. Pat. No. 5,706,099. In that case, in a matrix cell, in the corners thereof, two 90 degrees circular arcs are printed. The matrix cells are turned by 90 degrees for data coding. Different shades of grey are attained by circular arcs of different thicknesses. In U.S. Pat. No. 5,315,098 a further development is presented which improves the visual impact of the coded metric images.

It is common to the abovementioned state of the art that the data density of the codes is more limited than initially expected. The reason therefore is that, in digital printing technology it is virtually not possible to print individual matrix points. Closely adjoining lines as well easily merge together. The merging together of matrix points is even further enhanced by poor optics in the reading instruments. Using a laser printer having 1200 dpi the data strip described in U.S. Pat. No. 5,315,089 can store approximately 6000 bit/cm² (brutto data density without redundancy for error protection). In that case, in a single cell of 6×6 matrix points one information bit is stored.

In DE 199 26 194 a data strip and a process for encoding and decoding is described, by means of which it is possible by printing onto a data carrier to store digital data with a high data density and read them back thereafter. Such a memory may for example be used in order to store compressed audio data on paper and subsequently read these back with a simple hand-held instrument and replay them acoustically. The associated process resides in that a variety of two-dimensional patterns are printed onto the substrate, each of these patterns corresponding to one information bit or one bit sequence. During decoding, a two-dimensional pattern recognition is employed in order to reconstruct the bit sequence. The object of a high data density is attained in that in the data strips, at defined localities, known two-dimensional patterns are installed which carry no information. These patterns serve as training patterns for the reading instruments. If it should happen that during the printing process or in the reading instrument problems arise, such as e.g. a blending together of printing ink or poor definition in the optical image, such effects can be taken care of in the reading instrument.

In German patent application DE 103 45 669 A1 there is described moreover a data strip with copying protection and a process for encoding such data strips. The copying protection is attained in that the data carrier contains a locally random structural component, and a security code which differs from one data strip to the next is deposited as a counterfeiting and copying protection. The security code in this context depends on the random structural component. In the case of a printed data strip it is advantageous, besides the structural component of the data carrier, to also measure the interaction of the structural component with the printing ink to be inserted encoded as a security code.

In the practical performance of the process described in DE 103 45 669 A1 it is found that the measurement of the random structural component then becomes very difficult if the data strip had been printed with high resolution. Firstly, the printing dots will then easily flow together and this flowing together is a random process which only to a very limited extent is suitable for counterfeit protection. Secondly, a finite local resolution of the reading instrument causes the flowing together in the received image to become even more apparent. Within the data strip a usable random structure is then hardly determinable any more.

The invention has made it its object to image a matrix print applied to an object, such as in particular paper, in such a manner that it can be used as a memory and that, if the data density is increased, the problem of inter-merging of the ink will not lead to a destruction of the memory, as well as to provide a process for a corresponding simple encoding and decoding of the data. This object is attained according to the invention by the characterizing features of the main claim and the associated independent claim. The useful effect resides in that in a matrix cell additional information bits can be stored without more surface area being printed and without demands on the printing quality or the decoder increasing. As a result the technology is particularly suitable for the production of data strips with copying protection as described in DE 103 45 669 A1 or for the production of counterfeiting protected documents as described in DE 10 2005 013 962,

For attaining the object a matrix print for storing of encoded data with high data density is designed as follows. The surface to be printed of an object is sub-divided into mutually adjoining matrix cells of pre-designed configurations composed of matrix points. Into each matrix cell at least two different patterns R, I, . . . are imprinted in such a manner that each of the patterns R, I, . . .
i) is selected from pair-wise isohedric, non-overlapping patterns (Rₒ, R₁) respectively (Iₒ, I₁),
ii) borders by way of at least one matrix point onto another pattern of the same matrix cell and
iii) occupies different matrix points in the matrix cell.

In this manner, it is attained that in each matrix cell at least two information bits are stored. In the case of only two patterns R and I there is provided a so-called complex symbol comprising the real integer R and the imaginary integer I. The term symbol in this context denotes the logics associated with the printed patterns. According to the invention the patterns R, I, . . . are now so designed that they jointly form a coherent print area. Such coherent print areas make small demands on the printing technology for as long as the individual areas of different matrix cells do not lie too close together. Furthermore, due to the fact that each of the patterns R, I, . . . occupies different matrix points in the matrix cell, so-called orthogonal patterns are provided which later on can be distinguished particularly easily.

Since in accordance with claim 2, at least one of the patterns R, I, . . . adjoins the margin of the matrix cell and in addition at least one pattern R, I, . . . of another matrix cell, it becomes possible by reducing the size of the matrix cells to reduce the imprinted surface area, whereby the data density is increased. In this context the matrix cells are designed so small that thereby the printing areas extend to the borders of the matrix cells, but co-merge there specifically with the printed areas of other matrix cells. Thus the printing ink may purposely merge between the printing spots of different matrix cells without the overall printing image being changed in substance.

If, in accordance with claims 3 and 4, in some matrix cells, along the borders of the patterns R, I, . . . a defined number of matrix points is omitted or supplemented or if in a matrix cell the printed regions are interchanged for non-printed regions, it is possible to superpose the stored data with visual information without the data storage being substantially interfered with. The supplementation and omission of matrix points is also advantageous in order to attain printing spots which are as round as possible. It can, however, also be used for storing additional information in a matrix cell. In the case of a complex symbol one also talks of higher level complex symbols. If, for example, the patterns R and I each exist in a larger and a smaller font, it becomes possible to generate 16 different overall patterns and thus the encoding of 4 information bits in a single matrix cell is made possible. However, in order not to increase the printing quality needs it is important that, when supplementing and omitting the matrix point, the pattern of the real integer still adjoins the pattern of the imaginary integer.

The patterns R, I, . . . may, in accordance with to claim 5, be printed in different colors in order to superpose on the matrix print memory visually discernable colored graphics or, alternatively, to store additional digital information bits. In the latter case, the colors should be readily distinguishable by a scanner.

Claims 6 to 9 describe the use of the matrix print memory for counterfeiting protection of printed paper documents. In this context the matrix print memory may store on a relatively small surface area the entire contents of the document and/or the individual paper structure of the printed paper sheet. By the employment of known encrypting technology it thereby becomes possible later to check the integrity of the contents and/or each paper sheet is prepared for a subsequent copy recognition.

According to claim 7 each sheet of paper has advantageously printed thereon an additional calibration element for the subsequent error-free measurement of the individual paper structure. If, in a printed area of the calibration element only between 2% and 15% of the paper surface are covered by printing ink, the paper structure of the sheet will be captured simultaneously in a subsequent scanning procedure. In accordance with claim 8 calibration elements composed of mutually bordering matrix cells are particularly suitable. In adjoining matrix cells a sequence of at least two different patterns is printed and the sequence of patterns is repeated at least partly after 3×5 or 7×9 matrix cells. Such pattern sequences are particularly well suited for determining the transfer characteristics of reading instruments such as e.g. scanners. The initially surprising advantage of the repetition of pattern sequences 3×5 or 7×9 matrix cells is the result of known correlation properties of so-called two-dimensional m-sequences. A further advantage in the practical performance results from claim 9. By applying markings readable by humans and/or a machine which differ from one paper sheet to the next, the production of documents protected against counterfeiting is facilitated. The individual paper structure of each sheet can then be filed under this marking in a data bank. When producing the counterfeiting protected document use is made of this data bank. This procedure is of major practical utility. Once the data have been retrieved from the data bank, the data bank entry including the paper structure data can be deleted.

Claims 10 to 17 elucidate the process according to which the information bits or alternatively visual information can be encoded into the matrix cells and how with very simple means counterfeiting protected documents can be produced.

The major advantage of the described invention resides in the increase of the data density up to fourfold as compared with the state of the art without the demands in respect of printing quality or costs for the decoder being increased. The low demands on the printing quality are caused by the intermingling of patterns R, I, . . . as explained above. The easy and reliable decoding is caused by the orthogonality of the patterns R, I, . . . which will now be briefly elucidated for the case of complex two-valued symbols (R, I). After the scanning of the matrix printing image the calculation of the position of the matrix cells takes place in a timing determination. The image intensities of each matrix cell are then passed to a complex two-dimensional digital filter. With a suitable collection of the filter coefficients there results, based on the orthogonality of the patterns, at the filter outlet, and when noise free, one of the values (±3, ±1; ±j, ±3j), whereby 4 information bits are encoded. The suitable filter coefficients are found e.g. by solving a linear equation system according to the method of smallest squares. The complex linear combination of the image intensities of the matrix cell must then produce one of the values (±3, ±1; ±j, ±3j). In the present example four bits are decoded using a single complex filter. Even the computering effort per bit is thus reduced by a factor 2 as compared with the case when in one matrix cell only one bit has been stored.

A further advantageous method for the decoder is a dual-layer neuronal network NN, to which the image points of a matrix cell are fed. The dimension of the covered layer and the weighting are then optimized and determined by computer simulations. The advantage as compared with the first described filter method is the possibility for the NN to react to non-linearities of the printing image. Furthermore, the local resolution in the reading instrument can be reduced as shown by experiments which have not yet been explained theoretically. In concrete terms a 1200 dpi print can be scanned by a 1200 dpi scanner. When employing the filter method, based on the scanning theorem, a 2400 dpi scanner would be needed.

In the following the invention will be elucidated in more detail with reference to drawings and working examples. There is shown in:

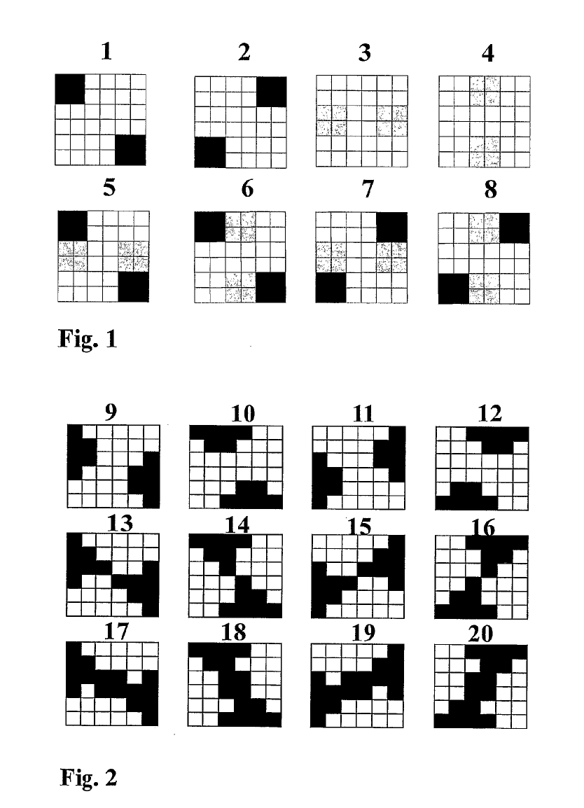

FIG. 1 the design of a complex symbol comprising a real integer and an imaginary integer,

FIG. 2 modifications of the printed patterns along the borders,

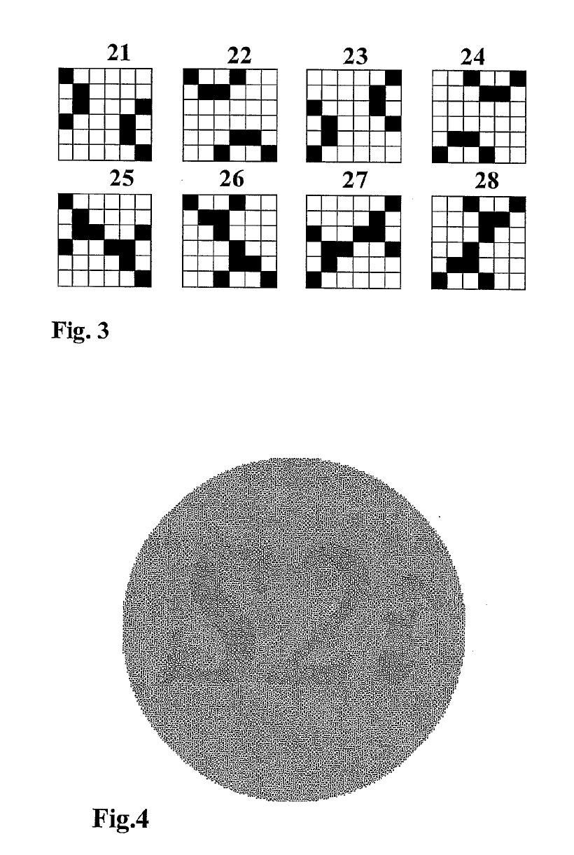

FIG. 3 further modifications of the printed patterns along the borders,

FIG. 4 an example of a matrix print memory,

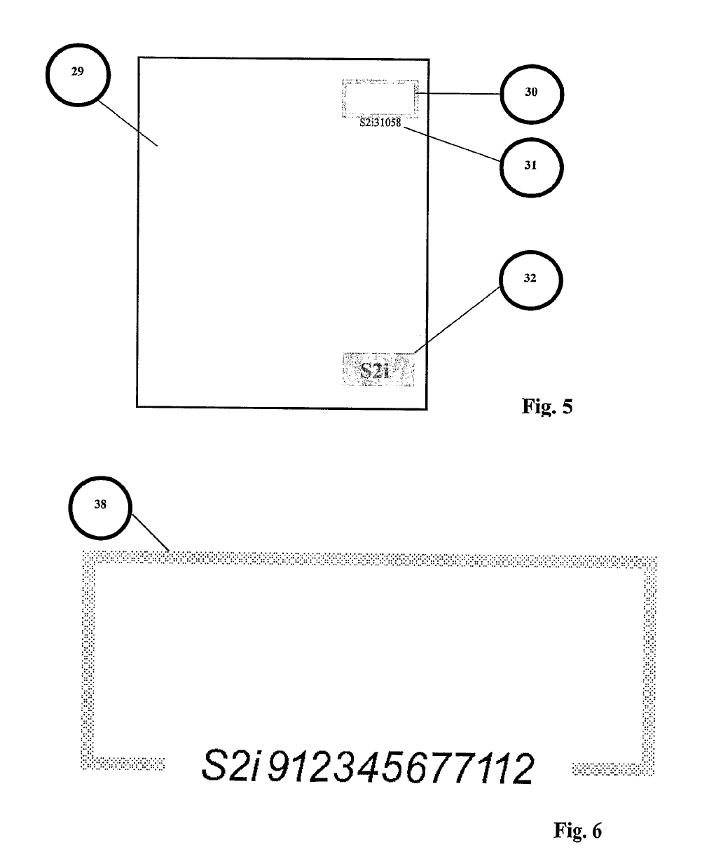

FIG. 5 the use of the matrix print memory on a document paper with calibration element,

FIG. 6 an especially advantageous design of calibration element,

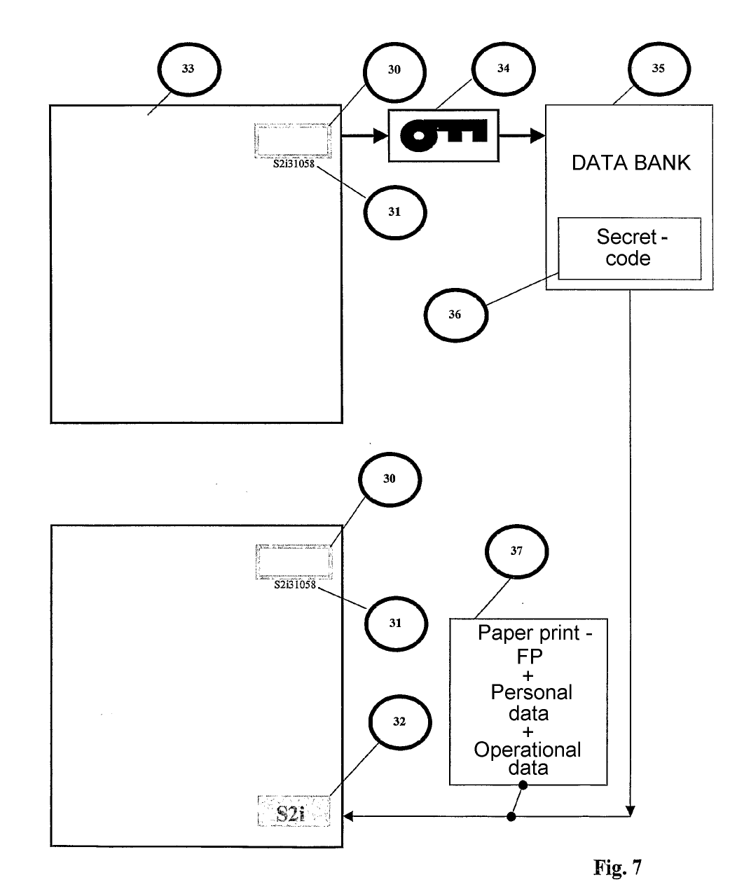

FIG. 7 the production of a counterfeiting protected document.

FIG. 1 shows matrix cells of 6×6 matrix points. In the matrix cell 5 a so-called complex Symbol is imprinted composed of the real integer R 1 and imaginary integer I 3. The real integer R is selected from the two patterns R₀ 1 or R₁ 2, likewise the imaginary integer I from the patterns I₀ 3 or I₁ 4. In a complex symbol two information bits can accordingly be stored. The patterns 1 and 2 associated with the real integer encode the information bits ZERO and ONE respectively. The patterns 3 and 4 associated with the imaginary integer likewise encode the information bits ZERO and ONE respectively. In the present example, in the matrix cell 5, the information bit sequence ZERO-ZERO was encoded. The matrix cells 6, 7 and 8 encode the information bit sequences ZERO-ONE, ONE-ZERO and ONE-ONE. As a result of the real integer and the imaginary integer of the complex symbol for each information bit sequence bordering on one another, coherent spots are formed which can be printed particularly readily. Each complex symbol moreover comprises two symmetrically arranged spots. This symmetry later on facilitates simple decoding. A further advantage is that each of the four composite overall patterns 5, 6, 7, 8 occupies different matrix points in the matrix cell. The four overall patterns are accordingly orthogonal in a mathematical sense. This provides the orthogonality between the real integer R and imaginary integer I required according to the invention. In the drawing the real integers and the imaginary integers are illustrated on purpose in different shades of grey for purposes of elucidation, although this is obviously not necessary in practice.

FIG. 2 shows the modification according to the invention of the patterns along the borders. The overall patterns 9, 10, 11 and 12 are formed from the overall patterns 5, 6, 7 and 8 in that along the borders in each case two matrix points are not occupied. In this manner the patterns of the real integer and the imaginary integer each lose one matrix point which in each case is along the edge of the overall pattern. The overall patterns 13, 14, 15 and 16 or 17, 18, 19 and 20 respectively are formed from the overall patterns 5, 6, 7 and 8 in that along the edges one or two matrix points respectively are occupied additionally. These matrix points make it possible to superimpose visual information on the matrix print in addition to the stored data. The more or the fewer matrix points are occupied the darker or brighter will the matrix cell appear to the eye. The additional matrix points, however, may also be used in order to encode additional data. For subsequent decoding it is advantageous that when occupying the marginal points in the overall patterns 13 to 20, the underlying patterns of the real integers and imaginary integers remain orthogonal.

FIG. 3 shows in the overall patterns 21, 22, 23, 24 and 25, 26, 27, 28 another modification of the marginal points which is particularly useful with printing processes in which the printing ink blend strongly.

FIG. 4 shows a matrix print memory employing the overall patterns 9 to 16. Since the patterns extend up to the borders of the matrix cells, they coalesce with the patterns of adjoining cells to form larger spots which makes particularly small demands on the printing process. When using a commercially available laser printer with 1200 dpi, the illustrated matrix print memory has a diameter of 2.07 cm and stores 41.2 kbit, which corresponds to a data density of 12400 bit/cm². This corresponds to a factor of two above the known state of the art. If the overlapping of the visual information is dispensed with, it is even possible to store and easily decode 18600 bit/cm².

FIG. 5 shows the use of the matrix print memory in conjunction with a document paper 29 with a calibration element 30. The calibration element 30 comprises a very fine overprint which serves to calibrate the scanner when testing the paper fingerprint. Defined optimized patterns are printed on which later on permit measuring the transfer function of the scanner and to compensate therefore as well as to find areas in which the paper fingerprint is measured. In addition, the document paper 29 contains an individual code number 31 which advantageously is integrated into the calibration element 30. The matrix print memory 32 contains the digital, encoded data of the paper fingerprint in the region of the calibration element 30 and further data such as, e.g. personal data for authentification of the author of the document.

FIG. 6 shows an advantageous design of the calibration element. The printing pattern 38 is derived from pseudo-random sequences and has a periodicity of 3×5 print elements. Such so-called two-dimensional m-sequences are particularly suitable for the calibration of the scanner. The print pattern 38 has moreover been designed on purpose with little contrast, so that in a scanning procedure simultaneously the paper structure is scanned. Depending on the printing ink used, contrasts between 2% and 15% are used.

FIG. 7 illustrates the process for a simple production of a counterfeit protected document. The document paper is initially an intermediate stuff 33 including the security element 30 printed on and preferably covered with a transparent foil. The intermediate stuff is manufactured at low cost in large numbers. The security element of each half stuff piece 33 is now scanned and the data are filed under an individual code number 31 in a data bank 35. The scanning of the intermediate stuff 33 can be performed with reliable document scanners at high velocity very cheaply and with highest quality. Preferably, the digital data are subjected to a data reduction and subsequent data compression with a view to the subsequent verification task; this can be done after the scanning procedure in a stack processing step, at times when the computer is not used to capacity. When producing a counterfeit protected document the data are read by way of the paper fingerprint from the data bank 35 and the intermediate stuff 33 is provided with the individualized matrix print memory 32. When computing the matrix print memory, the secret code 36 of a PKS (public key system) 34 is employed. The matrix print memory 32 stores the information concerning the paper fingerprint, personal data and operational data. In a special unit 37 these data may also be so combined that they become lost when a copy is produced.

1. Object such as, in particular, paper having applied thereon a matrix print for the storage of encoded data of high data density, the printed surface of the object being sub-divided into mutually adjoining matrix cells of pre-designed configuration composed of matrix points, and in each matrix cell at least two different patterns R, I, . . . being imprinted, characterised in that each of the patterns R, I, . . .
i) is selected from pair-wise isohedric, non-overlapping patterns (Ro, R1) respectively (Io, I1),
ii) borders by way of at least one matrix point onto another pattern of the same matrix cell and
iii) occupies different matrix points in the matrix cell.

2. Object with applied matrix print according to claim 1, characterised in that at least one of the patterns R, I, . . . borders onto the edge of the matrix cell and additionally onto at least one pattern R, I, . . . of a different matrix cell.

3. Object with applied matrix print according to at least one of the preceding claims, characterised in that in certain matrix cells along the edges of the patterns R, I, . . . a defined number of matrix points has been added or omitted.

4. Object with applied matrix print according to at least one of the preceding claims, characterised in that in a matrix cell, the printed areas have been interchanged with non-printed areas.

5. Object with applied matrix print according to at least one of the preceding claims, characterised in that the patterns R, I, . . . are printed in different colours.

6. Object with applied matrix print according to at least one of the preceding claims, characterised in that the object consists of paper and the matrix print memory stores digital data and/or the individual paper structure.

7. Object with applied matrix print according to claim 6, characterised in that the paper includes an additional printed-on calibration element, for which only between 2% and 15% of the paper surface is covered with printing ink.

8. Object according to claim 7, characterised in that the calibration element is composed of matrix cells, that in adjoining matrix cells a sequence of at least two different patterns is imprinted and the pattern sequence is repeated, at least in part, after 3×5 or 7×9 matrix cells.

9. Object according any one of claims 6 to 8, characterised in that from one paper sheet to the next, a differing code indexing readable by a human and/or a machine is applied.

10. Process for encoding of data by the application of a matrix print on an object, wherein the printed surface of the object is sub-divided into mutually adjoining matrix cells composed of matrix points and having a pre-defined configuration and in each matrix cell at least two patterns R, I, . . . are printed, characterised in that for the storage of at least two information bits, each of the patterns R, I, . . .
i) is selected from pair-wise isohedric, non-overlapping patterns (Ro, R1) respectively (Io, I1),
ii) borders by way of at least one matrix point onto another pattern of the same matrix cell and
iii) occupies different matrix points in the matrix cell.

11. Process according to claim 10, characterised in that at least one of the patterns R, I, . . . is printed bordering onto the edge of the matrix cell and additionally onto at least one pattern R, I, . . . of a different matrix cell.

12. Process according to at least one of claims 10 to 11, characterised in that for storing, at least one additional information bit at least one of the patterns R, I, . . . in information dependent manner, a defined number of matrix points along the edge are omitted or supplemented.

13. Process according to at least one of claims 10 to 12, characterised in that for the superposition of visual information in a matrix cell, the printed regions are interchanged for unprinted ones.

14. Process according to at least one of claims 10 to 13, characterised in that in a matrix cell the patterns R, I, . . . are printed in different colours in order to superpose visually discernable coloured graphics or alternatively, store additional digital information bits.

15. Process according to at least one of claims 10 to 14, characterised in that the matrix print memory is applied onto paper and thereby digital data and/or data concerning the individual paper structure are stored.

16. Process according to claim 15, characterised in that a paper is used which includes an additional printed on calibration element, only between 2% and 15% of the paper surface being covered with printing ink.

17. Process according to claim 16, characterised in that the paper used previously has printed thereon a calibration element composed of matrix cells, a sequence of at least two different patterns being printed in the adjoining matrix cells in such a manner that the pattern sequence is repeated at least partially after 3×5 or 7×9 matrix cells.

18. Process according to at least one of claims 15 to 17, characterised in that an identification code readable by a human and/or a machine and differing for each paper sheet is employed in order to read the data concerning the individual paper structure from a data bank.
